(19) United States
(12) Patent Application Publication
(10) Pub. No.: US 2004/0083112 A1
(43) Pub. Date: Apr. 29, 2004

(54) Method and apparatus for managing resources of utility providers

(76) Inventor: Gale R. Horst, Watervliet, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 10/280,902

(22) Filed: Oct. 25, 2002

(51) Int. Cl. G06F 17/60

(52) U.S. Cl. 705/1; 705/412

(57) ABSTRACT

A method and system for managing resources of various types of utility providers. An interface is configured to allow a consumer to select a rate plan having a limitation on resource usage, and to allow the consumer to select a level of participation in the rate plan. The consumer's actual resource usage is then monitored. A cost per unit of resource consumed is determined based on the selected rate plan and the actual resource usage, where the cost per unit is a first cost per unit if the actual resource usage is below the limitation and a second higher cost per unit if the actual resource usage exceeds the limitation. A total charge for the use of the resource is then calculated.

### BACKGROUND OF THE INVENTION

Many utility providers experience a shortage of resources due to increasing consumer demand, and more specifically, increasing peak demands for the resources. For example, generating plants are often unable to meet peak power demands resulting from an electricity load demanded by many consumers at the same time.

Presently, in an attempt to reduce high peak demands, many utility providers have instituted time of use rates which include higher rates for resource usage during on-peak times and lower rates for resource usage during off-peak times. However, these time of use rates do not include any incentives for increasing reductions in resource usage, nor do these types of rates allow users any flexibility in choosing a rate plan appropriate for their personal usage patterns. The time of use rates are also based solely on total resource consumption and as such do not provide a user with an incentive to reduce their peak instantaneous usage at any given time.

Therefore, there is a need to provide user with a process that allows for flexibility in selecting a rate plan and that provides an incentive for users to alter their resource usage patterns in such a way that reduces peak demands on the utility provider.

### SUMMARY OF THE INVENTION

The present invention provides a method and apparatus for managing resources of many different types of utility providers. In one aspect, the present invention provides a process for managing energy usage that includes providing an interface configured to allow a consumer to select a rate plan having a limitation on energy usage, and to allow the consumer to select a level of participation in the rate plan; monitoring actual energy usage by the consumer; determining a cost per unit of energy consumed, the cost per unit being a first cost per unit if the actual energy usage is below the limitation and a second cost per unit if the actual energy usage exceeds the limitation; the second charge rate being greater than the first charge rate; and calculating a total charge based on the charge rate and the actual energy usage.

In one embodiment, the limitation on energy usage may be an allowable number of kW hours of electricity within a period of time. The interface may then be configured to allow a consumer to select an amount of the allowable number of kW hours within a period of time. The user interface may also be configured to allow a consumer to select a first amount of allowable number of kW hours within a first period of time, and a second amount of allowable number of kW hours within a second period of time.

In another embodiment, the limitation on energy use may be an allowable number of instantaneous peak watts of electricity. Similar to the previous embodiment, the interface may then be configured to allow a consumer to select an amount of the allowable number of instantaneous peak watts. The interface may also be configured to allow a consumer to select a first amount of the allowable number of instantaneous peak watts for a first period of time, and a second amount of the allowable number of instantaneous peak watts for a second period of time.

In another aspect, the invention provides a method for managing energy usage including selecting a rate plan having a limitation on energy usage; selecting a level of participation for the rate plan including selecting an amount of the limitation on energy usage; monitoring actual energy usage; transmitting the actual energy usage to a utility provider paying a first cost per unit of energy consumed if an amount of the actual energy usage is less than the amount of the limitation; and paying a second cost per unit of energy consumed if an amount of the actual energy usage is greater than the amount of the limitation; the second charge rate being greater than the first charge rate.

In another aspect, the invention provides a system for managing energy usage in a residence, commercial or industrial establishment having a user interface, a power meter, and a billing system. The user interface is used to select a rate plan including a limitation on energy usage and a level of participation in the rate plan. The power meter is coupled to at least one electrical device in the establishment to monitor actual energy usage. The billing system is then adapted to receive from the user interface the rate plan and level of participation, and to receive from the power meter a signal including the actual energy usage. The billing system is also configured to determine a cost per unit of energy consumed, where the cost per unit is a first cost per unit if the actual energy usage is below the limitation and a second higher cost per unit if the actual energy usage exceeds the limitation.

In another aspect, the invention provides a method for managing resources including selecting a rate plan having an allowable instantaneous peak usage of a resource; monitoring an actual instantaneous peak usage of the resource; paying a first cost per unit of resource consumed if the actual instantaneous peak usage of the resource is less than the allowable instantaneous peak usage; and paying a second cost per unit of resource consumed if the actual instantaneous peak usage of the resource exceeds the allowable instantaneous peak usage.

In another aspect, the invention provides a method for managing resources including providing an interface configured to allow a consumer to select a rate plan having a allowable instantaneous peak usage of a resource; monitoring an actual instantaneous peak usage of the resource; determining a charge rate per unit of resource consumed, the charge rate being a first rate if the actual instantaneous peak usage is below the allowable instantaneous peak usage and a second rate if the actual instantaneous peak usage exceeds the allowable instantaneous peak usage; the second charge rate being greater than the first charge rate; and calculating a total charge based on the charge rate and the actual energy usage.

In another aspect, the present invention provides a system for managing consumption of resources in a residential, commercial or industrial establishment having an interface, a power meter and a billing system. The interface allows a user to select a rate plan having an allowable instantaneous peak usage of a resource. The power meter is then coupled to at least one electrical device in the establishment to monitor actual instantaneous peak usage. The billing system is adapted to receive the rate plan selected via the user interface and to receive the actual instantaneous peak usage from the power meter. The billing system is also configured to determine a cost per unit of energy consumed, where the cost per unit is a first cost per unit if the actual instantaneous peak usage is below the allowable instantaneous peak usage and a second higher cost per unit if the actual energy usage exceeds the allowable instantaneous peak usage.

### BRIEF DESCRIPTION OF THE FIGURES

FIG. 1 is a flowchart of one embodiment of the energy billing process;

FIG. 2 is an illustration of one exemplary rate plan;

FIG. 3 is an illustration of an exemplary rate plan having different limitations for different periods of the day; and

FIG. 4 is one embodiment of a system for performing the energy billing process.

### DETAILED DESCRIPTION

The present invention is directed to a method and apparatus for managing resources of utility providers and can be used in association with the provision of many different types of utilities and other resources. As a specific embodiment of the invention, a description is provided below with respect to the provision of energy, and specifically electricity, although the invention should not be deemed limited to the provision of electricity or even energy. The principles of the present invention may be applied to the provision of any resource, particularly where demand of the resource by consumers varies periodically over time. Use of the present invention may be useful in evening out the demand over selected periods of time.

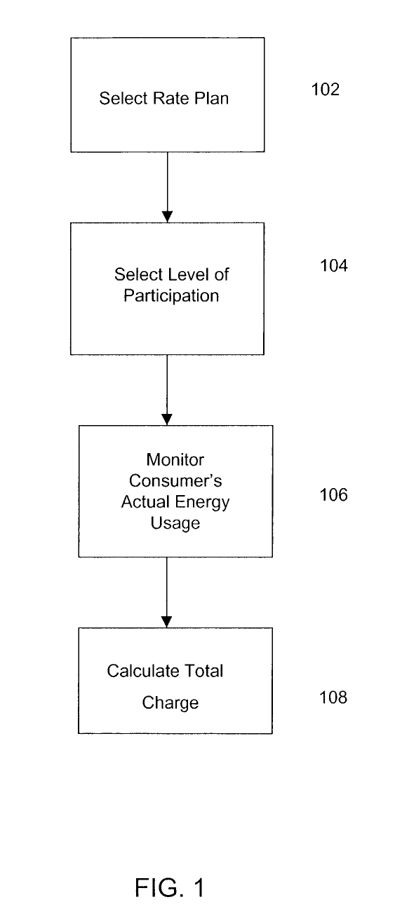

FIG. 1 illustrates an energy billing process that allows utility providers to manage consumer demand peaks for their resources. Specifically, the process provides consumers with incentives to maintain energy usage below specific limits, especially during on-peak hours, in order to obtain lower charge rates. As a result, consumers voluntarily decrease energy usage during peak usage times, which in turn decreases the peak energy demands on the utility provider.

In Step 102, the user first selects a rate plan, which is preferably selectable from a plurality of different types of rate plans. In one embodiment, the rate plan offered by a utility provider may be a scaled rate plan where the cost of the provided service varies according to the amount of energy used by the consumer. One exemplary rate plan, in which electricity is the energy, may include a limitation on the allowable number of kW hours for a specific period of time. The specific period of time may be certain hours during a day, certain days within a week, certain weeks in a month, or an entire month. The consumer may then be charged at a first rate for each kW hour consumed up to the total number of allowable kW hours. Any kW hours used during the period of time over the total amount would then be charged at a higher rate.

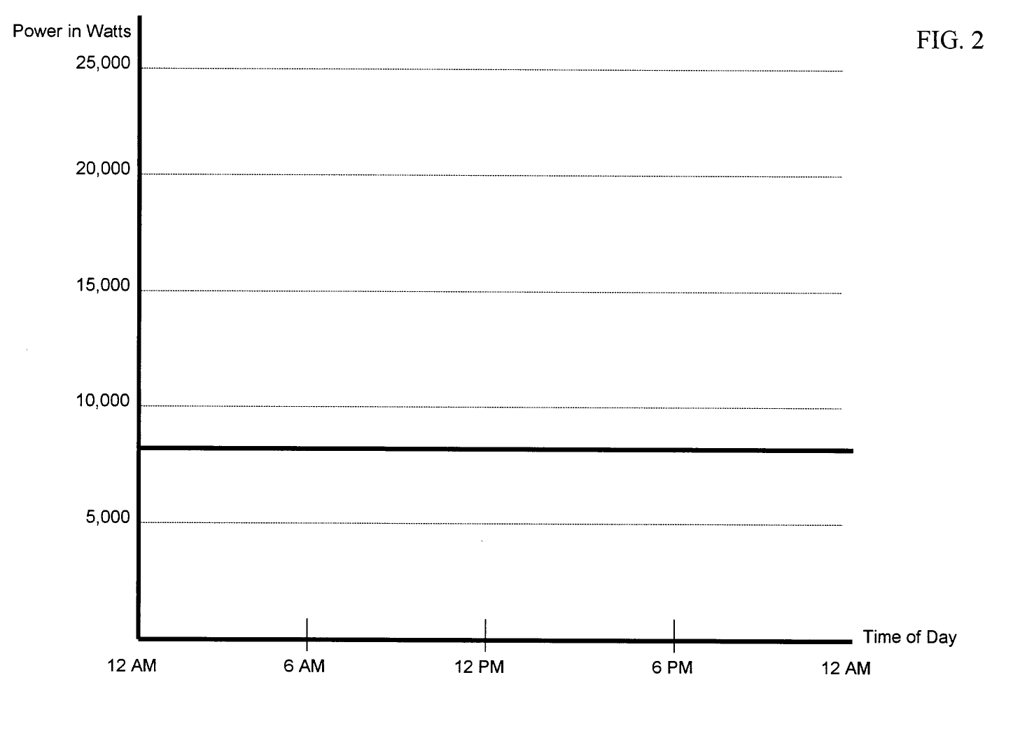

In another exemplary rate plan, the utility provider may offer a scaled rate that includes an allowable number of instantaneous peak watts that may be used by the consumer during a specific period of time. (see FIG. 2) The number of instantaneous peak watts for a household or residence is calculated as the total number of watts consumed at a single instant in time. The consumer may then be charged at a first rate as long as the consumer's instantaneous peak energy demand remains below the allowable number of instantaneous peak watts. If the consumer's peak energy demand exceeds the allowable number, the consumer is charged at a higher rate for the excess energy consumed.

Each of the rate plans discussed above may be structured as a penalty system or a reward system. For example, a consumer's charge rate may be increased if the consumer's energy usage exceeds either the allowable number of kW hours or the allowable number of instantaneous peak watts. Alternatively, the rate plan may be structured to reduce the consumer's rate charge if the consumer's energy usage is maintained below a predetermined number of kW hours or a predetermined number of instantaneous peak watts.

Once a consumer selects a rate plan, the user may next select a level of participation in the rate plan (Step 104). In this step, the user may vary or adjust the limitations, such as the allowable number of kW hours or the allowable number of instantaneous peak watts, for the selected rate plan. By varying these limitations, the consumer may proportionally vary the charge rate applied to the consumer's energy usage. More specifically, by decreasing the limitations, the consumer may proportionately decreases the cost for the energy consumed when below the limitation, while simultaneously proportionately increasing the cost for energy consumed in excess of the limitation. Conversely, increasing the limitation may proportionately increase the cost for energy consumed below the limitation and decrease the cost for energy consumed in excess of the limitation.

In one embodiment, if the user selected a rate plan having a limitation on the total allowable kW hours in a period of time, decreasing the amount of the allowable kW hours may result in a proportionate decrease in the cost per kW hours for the kW hours consumed up to the allowable number of hours. The decrease in the total amount of allowable kW hours may also result in a proportionate increase in the cost per kW hour consumed in excess of the total amount of allowable kW hours.

Similarly, if the user selected a rate plan having an allowable peak energy usage limitation, decreasing the amount of the allowable instantaneous peak watts may result in a proportionate decrease in the cost per kW hour consumed when peak usage is maintained below this limitation and also a proportionate increase in the cost per kW hour consumed when peak usage exceeds the limitation.

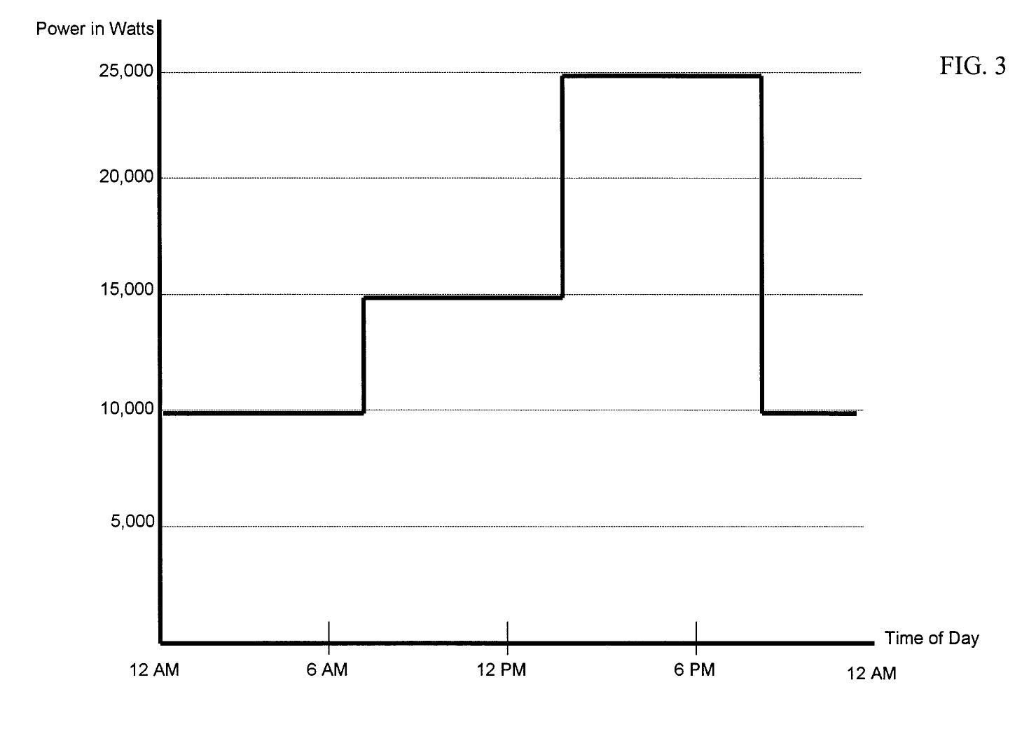

Additionally, the consumer may also select a different level of participation for different times of the day. For example, with respect to a rate plan having an allowable instantaneous peak energy usage limitation, the consumer may select to have a peak energy usage limitation of 15,000 instantaneous watts between the hours of 10:00 AM and 5:00 PM, a peak energy usage limitation of 25,000 instantaneous watts between 5:00 PM and 10:00 PM, and a peak energy usage limitation of 10,000 instantaneous watts between 10:00 PM and 10:00 AM. (see FIG. 3) The level of participation may also be varied for different days of the week, different months, or holidays.

The amount of the proportionate increase or decrease in cost may also vary depending on whether the selected portion of the day is an on-peak time or an off-peak time. For example, decreasing the allowable number of kW hours or the allowable instantaneous peak watts during on-peak times may provide a greater discount in the charge rate as compared to a decrease of the same amount of allowable kW hours during off-peak times. As such, the consumer may be presented with a greater incentive to reduce energy usage during on-peak times than during off-peak times.

The terms on-peak and off-peak, as used herein are meant to encompass time periods that an energy supplier has designated as referring to periods of high energy demand or cost and periods of low energy demand or cost, respectively. It may be that in some situations, multiple levels are designated by the energy supplier and thus on-peak is meant to refer to those periods where the energy demand or cost is greater than some other period, with the other period being referred to as off-peak. In any given situation, on-peak may not be the highest level and off-peak may not be the lowest level.

By allowing the consumer to select a level of participation, the consumer is able to configure the rate plan to conform to the consumer's pattern of energy usage and/or to achieve a particular savings by varying their usage pattern. Accordingly, to aid in selecting an appropriate type of rate plan and an appropriate level of participation for an individual consumer, the present invention may also provide the consumer with information regarding past and present energy usage. The consumer may also change his rate plan or level of participation at any time if the consumer's energy usage patterns change.

In Step 106, the consumer's actual energy usage is monitored and reported to the utility provider. In step 108 a total charge is calculated based on the appropriate charge rates defined by the selected rate plan, the level of participation, and the actual energy usage information received by the utility provider. A bill including the total charge is then transmitted to the consumer. The bill may be transmitted electronically via email, posted to a website, or by sent by regular mail.

In addition to the selectable rate plans as discussed above, the consumer may also receive offers or incentives from the utility provider. The offers or incentives may include opportunities for the consumer to accrue points by using less peak energy or total hours of energy during a stipulated period of time. These points may then be applied to either prizes or a reduction in billing costs. Preferably, these offers may be transmitted to the customer electronically by email, by posting the offer to a website, or by regular mail.

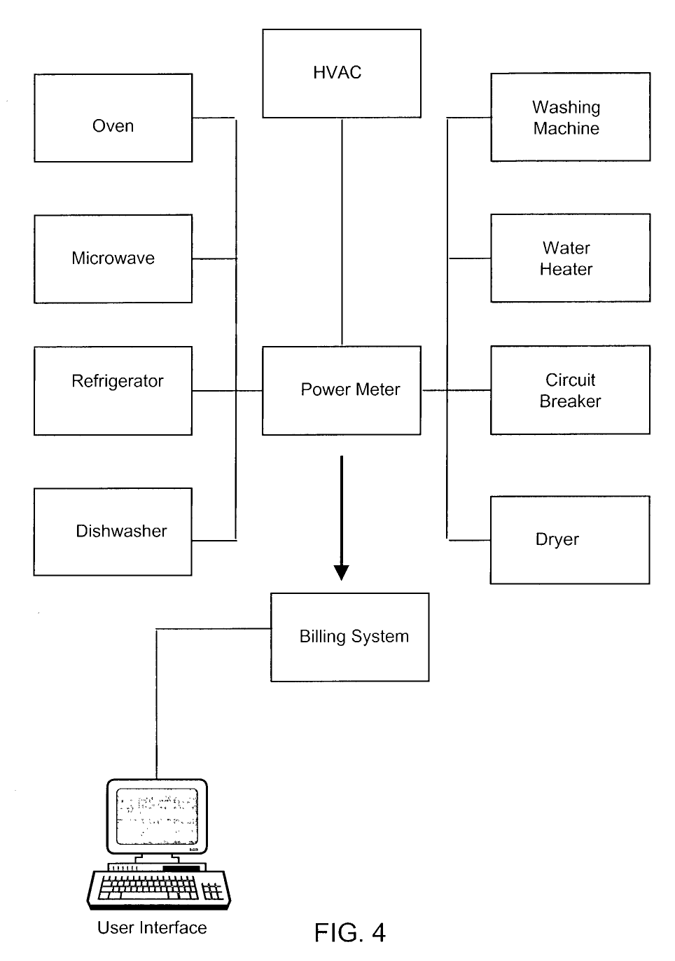

FIG. 4 is one embodiment of a system for practicing the energy billing process. The system includes a user interface 10, a power meter 20, and a billing system 30. The user interface may be a desktop computer, a laptop computer, a handheld computer or any other type of device capable of accessing the internet. In one embodiment, the user interface allows a consumer to access, via the internet, a server maintained by the utility provider in order to select a rate plan and a level of participation, as discussed above. Alternatively, the consumer may also contact the utility provider via mail or telephone to inform the utility provider of their choice of rate plan and level of participation.

The power meter monitors the energy used by appliances such as an oven, microwave, refrigerator, dishwasher, washing machine, clothes dryer, or any other device that uses electrical power. The power meter may be any type of known meter for measuring energy usage, and is preferably configure to transmit information about the consumer's energy usage to the billing system. This information may be transmitted continuously from the power meter to the billing system or on a periodic basis, such as once a month.

Once the billing system 30 receives the actual energy usage from the consumer's power meter, the billing system applies the appropriate rate charges as defined by the rate plan and level of participation selected by the consumer to determine a total charge. A bill including the total charge is then transmitted to the consumer, or some other mechanism is employed, such as direct debit.

While various embodiments of the application have been described, it will be apparent to those of ordinary skill in the art that many more embodiments and implementations are possible that are within the scope of this invention. Specifically, the energy billing process may also be used for providers of water, gas, internet access, or any other limited resource. Accordingly, the invention is not to be restricted except in light of the attached claims and their equivalents.

We claim:

1. A method for managing energy usage comprising:
providing an interface configured to allow a consumer to select a rate plan having a limitation on energy usage, and to allow the consumer to select a level of participation in the rate plan;
monitoring actual energy usage by the consumer;
determining a cost per unit of energy consumed, the cost per unit being a first cost per unit if the actual energy usage is below the limitation and a second cost per unit if the actual energy usage exceeds the limitation; the second charge rate being greater than the first charge rate; and
calculating a total charge based on the charge rate and the actual energy usage.

2. The method of claim 1 wherein the rate plan is selected from a plurality of rate plans.

3. The method of claim 1 wherein the limitation on energy usage is an allowable number of kW hours of electricity within a period of time.

4. The method of claim 3 wherein the interface is configured to allow a consumer to select an amount of the allowable number of kW hours within a period of time.

5. The method of claim 4 wherein the interface is configured to allow a consumer to select a first amount of allowable number of kW hours within a first period of time, and a second amount of allowable number of kW hours within a second period of time.

6. The method of claim 1 wherein the limitation on energy use is an allowable number of instantaneous peak watts of electricity.

7. The method of claim 6 wherein the interface is configured to allow a consumer to select an amount of the allowable number of instantaneous peak watts.

8. The method of claim 7 wherein the interface is configured to allow a consumer to select a first amount of the allowable number of instantaneous peak watts for a first period of time, and a second amount of the allowable number of instantaneous peak watts for a second period of time.

9. A method for managing energy usage comprising:
selecting a rate plan having a limitation on energy usage;
selecting a level of participation for the rate plan including selecting an amount of the limitation on energy usage;
monitoring actual energy usage;
transmitting the actual energy usage to a utility provider
paying a first cost per unit of energy consumed if an amount of the actual energy usage is less than the amount of the limitation; and
paying a second cost per unit of energy consumed if an amount of the actual energy usage is greater than the amount of the limitation; the second charge rate being greater than the first charge rate.

10. The method of claim 9 wherein the rate plan is selected from a plurality of rate plans.

11. The method of claim 9 wherein the limitation on energy usage is an allowable number of kW hours of electricity within a period of time.

12. The method of claim 11 wherein the step of selecting a level of participation includes selecting an amount of the allowable number of kW hours within a period of time.

13. The method of claim 12 wherein the step of selecting a level of participation includes selecting a first amount of allowable number of kW hours within a first period of time, and a second amount of allowable number of kW hours within a second period of time.

14. The method of claim 9 wherein the limitation is an allowable number of instantaneous peak watts of electricity.

15. The method of claim 14 wherein the step of selecting a level of participation includes selecting an amount of the allowable number of instantaneous peak watts.

16. The method of claim 15 wherein the step of selecting a level of participation includes selecting a first amount of the allowable number of instantaneous peak watts for a first period of time, and a second amount of the allowable number of instantaneous peak watts for a second period of time.

17. A system for managing energy usage in a establishment comprising:
a user interface to select a rate plan including a limitation on energy usage and a level of participation in the rate plan;
a power meter coupled to at least one electrical device in the establishment to monitor actual energy usage;
a billing system adapted to receive from the user interface the rate plan and level of participation, and to receive from the power meter a signal including the actual energy usage; the billing system being configured to determine a cost per unit of energy consumed, the cost per unit being a first cost per unit if the actual energy usage is below the limitation and a second cost per unit if the actual energy usage exceeds the limitation; the second cost per unit being greater than the first cost per unit.

18. The system of claim 17 wherein the limitation on energy usage is an allowable number of kW hours of electricity within a period of time.

19. The system of claim 18 wherein the level of participation includes an amount of the allowable number of kW hours within a period of time.

20. The system of claim 19 wherein the level of participation includes selecting a first amount of allowable number of kW hours within a first period of time, and a second amount of allowable number of kW hours within a second period of time.

21. The system of claim 17 wherein the limitation on energy use is an allowable number of instantaneous peak watts of electricity.

22. The system of claim 21 wherein the level of participation includes an amount of the allowable number of instantaneous peak watts.

23. The system of claim 22 wherein the level of participation a first amount of the allowable number of instantaneous peak watts for a first period of time, and a second amount of the allowable number of instantaneous peak watts for a second period of time.

24. A method for managing resources comprising:
selecting a rate plan having an allowable instantaneous peak usage of a resource;
monitoring an actual instantaneous peak usage of the resource;
paying a first cost per unit of resource consumed if the actual instantaneous peak usage of the resource is less than the allowable instantaneous peak usage; and
paying a second cost per unit of resource consumed if the actual instantaneous peak usage of the resource exceeds the allowable instantaneous peak usage.

25. The method of claim 24 wherein the rate plan includes first amount of allowable instantaneous peak usage during a first period of time and a second amount of allowable instantaneous peak usage during a second period of time.

26. A method for managing resources comprising:
providing an interface configured to allow a consumer to select a rate plan having a allowable instantaneous peak usage of a resource;
monitoring an actual instantaneous peak usage of the resource;
determining a charge rate per unit of resource consumed, the charge rate being a first rate if the actual instantaneous peak usage is below the allowable instantaneous peak usage and a second rate if the actual instantaneous peak usage exceeds the allowable instantaneous peak usage; the second charge rate being greater than the first charge rate; and
calculating a total charge based on the charge rate and the actual energy usage.

27. The method of claim 26 wherein the rate plan includes first amount of allowable instantaneous peak usage during a first period of time and a second amount of allowable instantaneous peak usage during a second period of time.

28. A system for managing consumption of resources in an establishment comprising:
an interface to select a rate plan having an allowable instantaneous peak usage of a resource;
a power meter coupled to at least one electrical device in the establishment to monitor actual instantaneous peak usage;
a billing system adapted to receive the rate plan selected via the interface and to receive the actual instantaneous peak usage from the power meter; the billing system being configured to determine a cost per unit of energy consumed, the cost per unit being a first cost per unit if the actual instantaneous peak usage is below the allowable instantaneous peak usage and a second cost per unit if the actual energy usage exceeds the allowable instantaneous peak usage; the second cost per unite being greater than the first cost per unit.

29. The method of claim 28 wherein the rate plan includes a first amount of allowable instantaneous peak usage during a first period of time and a second amount of allowable instantaneous peak usage during a second period of time.
